(19) United States
(12) Patent Application Publication
(10) Pub. No.: US 2005/0058174 A1
(43) Pub. Date: Mar. 17, 2005

(54) Solid state laser using a semiconductor pumping light source

(76) Inventor: Minoru Kadoya, Yokohama-shi (JP)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/810,693

(22) Filed: Mar. 29, 2004

(30) Foreign Application Priority Data
Sep. 17, 2003 (JP) 2003-323841

(51) Int. Cl. H01S 3/14; H01S 3/08

(52) U.S. Cl. 372/68; 372/70; 372/39

(57) ABSTRACT

In an end pumped or axially pumped solid state laser using a laser diode as a pumping light source, the laser crystal comprises a plurality of individual laser crystals arranged along an axial direction that have progressive higher concentrations of rare earth irons toward the output end. By thus arranging the individual laser crystals containing varying concentrations of rare earth ions, the absorption of laser for each length can be made uniform so that the tolerance for a high power pumping light is increased, and the laser output can be maximized without damaging the laser crystal.

### CROSS REFERENCE TO RELATED APPLICATIONS

The present application claims priority from Japanese application No. 2003-323841, filed Sep. 17, 2003.

### TECHNICAL FIELD

The present invention relates to end pumped or axially pumped solid state lasers using a semiconductor device such as a laser diode as a pumping light source, and in particular to such lasers capable of producing a large output without the risk of the intense pumping light damaging the laser crystal.

### BACKGROUND OF THE INVENTION

Various forms of solid state lasers using a semiconductor light source and a laser crystal added with rare earth ions have been proposed. In particular, end pumped or axially pumped lasers of this type are particularly preferred because of the ease in achieving a mode matching between the pumping light and laser output. Therefore, a relatively high efficiency can be achieved in converting the pumping light into the output laser light as compared with the side pumped solid state lasers. Obtaining TEM₀₀ in spatial mode can be relatively easily achieved while maintaining a high conversion efficiency. Because of the high conversion efficiency, the pumping light source may consist of a laser diode of a relatively small output as compared with that of a side pumped laser, and this contributes to the reduction in the manufacturing cost.

As an example, a laser diode having a light emitting area of 10 mm×1 μm and an output of about 40 W was used as a pumping light source. The output light of the laser diode was focused into a light beam of a 600 μm square cross section by using the system disclosed in Japanese patent No. 3,098,200 to end pump a laser crystal (gain medium). It is also possible to suitably shape the pumping light beam by using the arrangement disclosed in U.S. Pat. No. 5,805,748 issued to Izawa. The contents of these patents are incorporated in this application by reference.

The laser crystal consisted of Nd:YVO₄ or yttrium vanadate containing a 0.5 atomic % of neodymium ion Nd³⁺ to produce a laser light having a wavelength of 1,064 nm. The laser crystal consisted of a rod having a square cross section (3 mm×3 mm×5 mm) having its long axis extending in the axial direction. This solid state laser had an output power of about 9 W at 1,064 nm when the output power of the laser diode was 20 W.

A Q-switch using an acousto-optical effect was placed in the laser resonator. When the Q switch was operated at the frequency of 20 kHz while the laser diode was in continuous operation, an averaged power output of 8 W was obtained. When a non-linear optical crystal was placed in the resonator to generate the second harmonic wave and the reflector was adapted to selectively reflect the oscillating laser beam from Nd:YVO₄ while the reflectivity for the second harmonic was extremely small, it was possible to produce a laser light having a wavelength of 532 nm at an output of up to 6 W.

However, in case of an end pumped or axially pumped solid state laser using a laser diode as a light source, as the output of the light source or the laser diode is increased to increase the laser output, the input end of the laser crystal may be damaged by the incident light. Also, excessive thermal stress may be caused in the laser crystal because the temperature rise and thermal expansion in the laser crystal is uneven, and this may even destroy the laser crystal.

When an input light is applied to a laser crystal, the power of the input light exponentially diminishes as it travels through the laser crystal. Therefore, a large part of the energy of the input light is absorbed by the input end of the laser crystal so that the input end of the laser crystal is prone to damages. To avoid damages to the laser crystal owing to such a factor and ensure the integrity of the laser, it was necessary to limit the intensity of the input light, and this dictated the maximum output of the laser.

In the case of the example given above, about a half of the energy of the input light was absorbed by the part of the laser crystal which is within 0.5 mm from the input end although the laser crystal was 5 mm long. When the power of the input light was increased to 25 to 30 W, the input end of the laser crystal was destroyed. The maximum tolerable power of the input light depends on the diameter of the input light, the wavelength of the input light, material property and optical surface finish of the laser crystal, but the output could not be increased beyond 20 W for practical purposes.

The susceptibility of the laser crystal to damages can be reduced by lowering the concentration of rare earth ions in the laser crystal to reduce the absorption of the input light by the input end portion of the laser crystal. However, when the concentration of the rare earth ions is reduced, the length of the laser crystal is required to be increased for the desired laser output to be achieved. Therefore, when a high output laser diode is used as a light source, even if the input light beam is properly shaped, it is difficult to have the input light travel through the laser crystal while maintaining an extremely small beam diameter, and the beam diameter undesirably increases as it travels through the laser crystal.

This in turn causes a higher transverse mode, thereby impairing the beam quality and pumping density. As a result, a desired efficiency cannot be achieved. In particular, when the material of the laser crystal has a high absorption coefficient, even if a laser crystal such as Nd:YVO₄ crystal having a high tolerance for the wavelength of the pumping light is used, reducing the concentration of rare earth ions tends to make the laser output highly dependent on the wavelength of the pumping laser light.

Japanese patent No. 3,266,071 is directed to a laser which is somewhat different from those that are end pumped or axially pumped, but includes a proposal to cool the laser crystal by attaching a heat sink made of metallic material to an end face of the laser crystal in the form of a thin plate, use the cooled end surface as a reflecting surface for the pumping light or laser output, and increase the concentration of rare earth ions progressively toward the cooled surface in a continuous or step-wise manner for the purpose of preventing an intense pumping light from damaging the laser crystal. The pumping is performed from the end facing away from the cooled face. According to this arrangement, a relatively large amount of heat is generated near the cooled face so that the overall cooling efficiency is improved. However, this arrangement is not suited for mass production because the axes of the pumping light and output laser are not coaxial and this makes the optical adjustment highly difficult.

### BRIEF SUMMARY OF THE INVENTION

In view of such problems of the prior art, a primary object of the present invention is to provide a laser diode pumped solid state laser of an end pumped or axially pumped type that can make the heat generation owing to the absorption of pumping light uniform over the length of the laser crystal.

A second object of the present invention is to provide such a solid state laser that can increase the laser output by allowing pumping light of a relatively high radiation energy to be applied to the laser crystal without damaging the same.

As a result of the research conducted by the inventor on the cause of the destruction of the laser crystal when subjected to a high intensity pumping light, it was discovered that a most part of the absorption of the radiation energy of the pumping light occurs in a region near the input end of the laser crystal while the remaining part of the laser crystal generates such a small amount of heat that there is a significant amount of margin of safety. The inventor therefore realized that the tolerance for the intensity of the pumping light can be increased by reducing the absorption of the pumping light radiation near the input end of the laser crystal and increasing the absorption of the pumping light radiation in the region remote from the input end of the laser crystal. Thereby, the heat generation is spread over the length of the laser crystal, and the overall tolerance of the laser crystal to the intensity of the pumping light can be increased. It is particularly desirable if the laser crystal is cooled from the side faces thereof. By thus favorably cooling the laser crystal, the necessary length of the laser crystal can be reduced without the risk of damaging the laser crystal.

How the absorption of the pumping light radiation occurs is now described in the following with reference to FIGS. 6 to 8. FIG. 6a shows the absorption dP(z)/dz for a unit length in the direction of laser propagation. The absorption of laser radiation for a unit length is required to be low enough not to cause damages to the laser crystal. It is ideal if the absorption is uniform over the entire length as shown in FIG. 6a. For this to be the case, it is necessary for the absorption to diminish with the increase in z at a constant rate as shown in FIG. 6b. In FIG. 6b, the power P₁ diminishes to one tenth of the incident power P₀ at the distance of 1.25 mm from the input end, and 90% of the pumping light is absorbed when the pumping light has traveled 1.25 mm.

To achieve the pattern of absorption shown in FIG. 6b, it is necessary to vary the absorption coefficient in the laser crystal as shown in FIG. 6c. The absorption coefficient is 7.5 cm⁻¹ at z=0, and this is achieved by a laser crystal Nd:YVO₄ having a Nd³⁺ concentration of 0.25 atomic % when applied to pumping light at 808 nm. This pattern of absorption can be achieved by varying the concentration of rare earth ions in relation to the position z according to the curve shown in FIG. 6c.

However, it is not possible with the available technologies to produce a laser crystal having a distribution of rare earth ion concentration as shown in FIG. 6c. The inventor realized that it can be approximately achieved by using a plurality of individual laser crystals having different rare earth ion concentrations and arranged in the axial direction. Such individual laser crystals may be bonded to one another, placed in close contact with one another or spaced from one another.

Such an arrangement is illustrated in FIGS. 7a to 7c. FIG. 7c shows a pattern of concentration that is achieved by integrally joining three individual crystals or laser crystals having different rare earth ion concentrations. The individual laser crystals all consist of Nd:YVO₄ and have Nd³⁺ concentrations of 0.25 atomic %, 0.5 atomic % and 1.0 atomic %, respectively, in that order from the input end. The individual laser crystals are 0.9 mm, 0.5 mm and 0.3 mm in thickness, respectively, and have absorption coefficients of 7.5 cm⁻¹, 15 cm⁻¹ and 30 cm⁻¹, respectively, in that order from the input end. The Nd³⁺ concentration of the individual laser crystal on the input end is selected in such a manner that the laser crystal would not be damaged if the entire laser crystal consisted of this individual laser crystal alone.

The power of the pumping light P(z) changes with the position z as shown in FIG. 7b. P₁ indicates the power of the pumping light at the position z=1.7 mm, and is one tenth of the power of the incident pumping light in this example. By thus combining three individual laser crystals, 90% of the pumping light can be absorbed by the laser crystal having the length of 1.7 mm. FIG. 7a shows the distribution of the absorption of the pumping light for each unit length along the axial direction.

The lengths of the individual laser crystals were selected such that the second and third absorption power peaks would not exceed the absorption power peak at z=0. The individual laser crystals are closely contacting one another or bonded to one another in the example shown in FIGS. 7a to 7c, but similar results can be obtained even when the individual laser crystals are spaced from one another by a gap substantially smaller than the length of the individual laser crystals. By using a larger number of individual laser crystals, it is possible to achieve a concentration distribution closer to the ideal one shown in FIGS. 6a to 6c. It is also possible to use only two individual laser crystals, and achieve a satisfactory result.

FIGS. 7a to 7c also show by the broken lines the distribution of the absorption coefficient, changes in the power of the pumping light and distribution of absorbed pumping light power in the case of a solid state laser using a single crystal laser crystal having a Nd³⁺ concentration of 0.25 atomic %. In the case of the single crystal laser crystal, it had to be 3.2 mm long to absorb 90% of the pumping light. The same amount of pumping light can be absorbed by a laser crystal which is only 1.7 mm long when it consisted of three individual laser crystals.

The heat generated from the individual laser crystals is essentially contained in the corresponding individual laser crystals. Therefore, when the side faces of the individual laser crystals, as opposed to the faces through which pumping laser or laser output passes, are held by heat removing means such as heat sinks, the generated heat can be removed in the direction perpendicular to the direction of the propagation of the laser. This also contributes to the even distribution of the absorption of the pumping laser.

The solid state laser according to the present invention can be made particularly suitable for mass production when the laser crystal consists of two individual laser crystals. The individual laser crystals are spaced from each other by a small gap. It is particularly preferable to use Nd:YVO₄ for the laser crystal because it can provide a high efficiency owing to its high induction emission cross section although it demonstrates a high absorption coefficient for the pumping light and is prone to physical damages.

The first individual laser crystal is required to have a Nd³⁺ concentration which is low enough not to be damage by the pumping laser as the pumping laser first enters the laser crystal from here. When an output light from a 40 W laser diode is focused into a diameter of 600 fÊm to pump a laser crystal, the Nd³⁺ concentration should be in the range of 0.2 to 0.3 atomic % for the required pumping to be accomplished without damaging Nd:YVO₄. The required length of the laser crystal is 1.1 mm to 1.7 mm, and should be acceptable for most applications. If the concentration is reduced from this level, the length of the laser crystal required for the adequate absorption of the pumping laser becomes longer, and this causes the density per unit area to be reduced since the quality of the beam of a laser diode for pumping is not high. Therefore, the Nd³⁺ concentration should be preferably in the range of 0.2 to 0.3 atomic %.

The Nd³⁺ concentration of the second laser crystal should be as high as possible for absorbing the part of the pumping laser that has not been absorbed by the first laser crystal, but should not be so high as to unduly impair the resonating efficiency. Nd:YVO₄ having a Nd³⁺ concentration of up to 2 to 3 atomic % is available, but the Nd³⁺ concentration should be preferably in the range of 1.0 to 1.1 atomic % because the upper level life time of Nd:YVO₄ is approximately 90 μsec when the Nd³⁺ concentration is no more than 1.0 or 1.1 atomic % without regard to the concentration level and progressively diminishes as the concentration level exceeds 1.1 atomic %, dropping to 50 μsec when the concentration is 2.0 atomic %. Because the upper level life time of 50 μsec is too short for an acceptable laser efficiency, the Nd³⁺ concentration should be in the range of 1.0 to 1.1 atomic %.

The optimum length of the Nd:YVO₄ crystal having such a range of Nd³⁺ concentration is discussed in the following. FIG. 8a shows the absorption power per unit length when two individual laser crystals are arranged one next to the other, and FIG. 8b shows the power of the pumping laser traveling through the Nd:YVO₄ crystal in relation with the position. The solid line curves in FIGS. 8a and 8b correspond to the case where the first individual laser crystal has a Nd³⁺ concentration of 0.3 atomic % and 1.5 mm in length and the second individual laser crystal has a Nd³⁺ concentration of 1.1 atomic %. The length of the second individual laser crystal was selected in such a manner that the absorption power at the input region of the second individual laser crystal is substantially equal to that of the input region of the first individual laser crystal. By selecting the length of the first individual laser crystal to be 1.5 mm, the damage to the second individual laser crystal owing to the absorption of the pumping light can be avoided, and the total length of the laser crystal can be minimized because the combination of these concentration levels allow a most part of the pumping laser to be absorbed.

The broken line curves in FIGS. 8a and 8b correspond to the case where the first crystal is 2.9 mm long and 0.2 atomic % in Nd³⁺ concentration and the second crystal is 1.1 atomic % in Nd³⁺ concentration. The length of the second crystal is determined in a similar manner as in the case where the Nd³⁺ concentration was 0.3 atomic % corresponding to the solid line curves in FIGS. 8a and 8b. In this manner, the first laser crystal was 1.5 mm to 2.9 mm in length and 0.2 to 0.3 atomic % in Nd³⁺ concentration. If the Nd³⁺ concentration of the first crystal was 0.2 to 0.3 atomic %, almost 100% of the pumping light can be absorbed by selecting the length of the second crystal to be 1 mm or longer as can be appreciated from FIG. 8b. As it is also the case when the Nd³⁺ concentration of the second crystal is 1.0 atomic %, the length of the second crystal should be 1 mm or longer.

When the wavelength of the output laser is 1.06 μm or 1.34 μm, the part to which the pumping light does not reach would not contribute to the pumping, but would not obstruct the pumping either. Therefore, there is no upper limit to the length of the second crystal in generating laser. The length may be selected at will as long as the assembling is kept simple and the cost is not unfavorably affected. Even when the laser crystal consists of only two individual laser crystals, only by suitably selecting the material for the laser crystals, Nd³⁺ concentration and length of the laser crystals, results similar to those attained by combing three individual laser crystals can be attained, and the cost of the laser can be minimized.

Based on such recognitions, the present invention improves a solid date laser by providing a solid state laser, comprising: a laser resonator including an output mirror, a laser crystal containing rare earth ions and at least one reflecting mirror, the output mirror, laser crystal and reflecting mirror being arranged along an optical axis, a laser diode for emitting pumping light; a pumping optical system for focusing pumping light emitted from the laser diode onto the laser resonator coaxially with the optical axis; wherein the laser crystal comprises a plurality of individual laser crystals arranged along the optical axis, the individual laser crystals being each made of a material having a composition expressed by a same chemical formula and having progressive higher concentrations of the rare earth ions toward the output mirror.

That the individual laser crystals are each made of a material having a composition expressed by a same chemical formula means that they consist of a combination of same elements. By thus arranging the individual laser crystals containing varying concentrations of rare earth ions but a same combination of elements, the absorption of laser for each length can be made uniform so that the tolerance for a high power pumping light is increased, and the laser output can be maximized without damaging the laser crystal. In particular, when the laser crystal is provided with a heat sink on side faces thereof for removal of heat, the advantages of the present invention are particularly enhanced.

When the individual laser crystals are prepared to have different rare earth ion concentrations and to be otherwise similar to one another, the laser crystal can be prepared substantially more economically than a single-piece laser crystal having a continually varying rare earth ion concentration distribution. Also, the multi-piece or composite laser crystal pumped from one end surface simplifies the alignment, and is suitable for mass production.

When the individual laser crystals are integrally bonded to each other by thermal bonding or other modes of bonding, the alignment and other manufacturing processes as well as stocking of the components are simplified.

If the individual laser crystals are disposed simply in close mutual contact or the individual laser crystals are spaced from each other by a gap substantially smaller than a length of a shortest one of the individual laser crystals, the manufacturing cost can be minimized.

### BRIEF DESCRIPTION OF THE DRAWINGS

Now the present invention is described in the following with reference to the appended drawings, in which:

FIG. 1 is a diagram showing a laser diode pumped solid state laser (a first embodiment) according to the present invention;

FIG. 2 is a diagram showing a second embodiment of the present invention;

FIG. 3 is a diagram showing a third embodiment of the present invention;

FIG. 4 is a diagram showing a fourth embodiment of the present invention;

FIG. 5 is a diagram showing a fifth embodiment of the present invention;

FIG. 6a is a graph showing the ideal relationship between the power absorption per unit length with the distance from the input end;

FIG. 6b is a graph showing the ideal relationship between the normalized pumping light power with the distance from the input end;

FIG. 6c is a graph showing the ideal relationship between the absorption coefficient with the distance from the input end;

FIG. 7a a graph showing the relationship between the power absorption per unit length with the distance from the input end when the laser crystal consists of three individual laser crystals;

FIG. 7b is a graph showing the relationship between the normalized pumping light power with the distance from the input end when the laser crystal consists of three individual laser crystals;

FIG. 7c is a graph showing the relationship between the absorption coefficient with the distance from the input end when the laser crystal consists of three individual laser crystals;

FIG. 8a a graph showing the relationship between the power absorption per unit length with the distance from the input end when the laser crystal consists of two individual laser crystals; and

FIG. 8b is a graph showing the relationship between the normalized pumping light power with the distance from the input end when the laser crystal consists of two individual laser crystals.

### DETAILED DESCRIPTION OF THE PREFERRED EMBODIMENTS

### First Embodiment

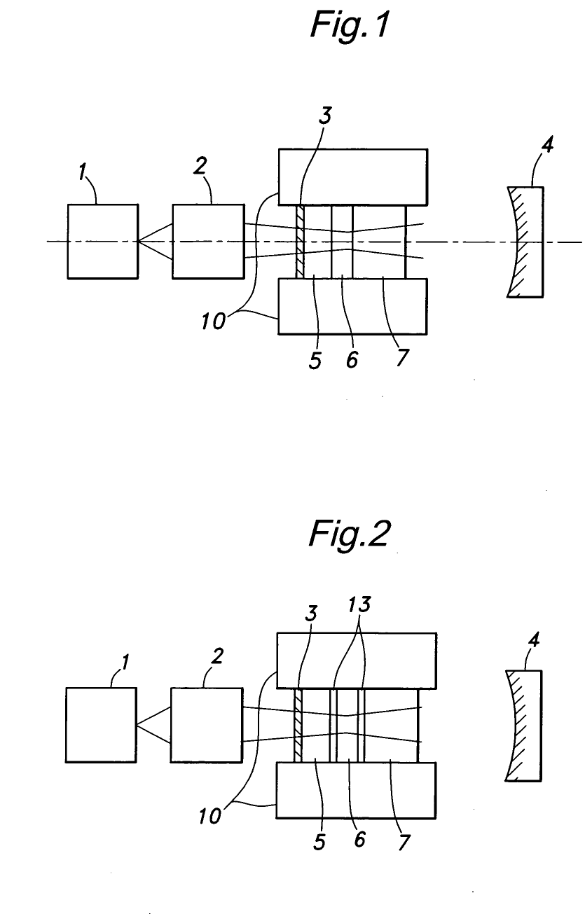

FIG. 1 shows a first embodiment of the present invention in the form of a laser diode pumped solid state laser. The pumping source of this laser consists of a laser diode 1 having a continuous output of 40 W at 809 nm, and has a light emitting area which is 10 mm wide and 1 μm high. The output of this laser diode is focused by an optical assembly 2 similar to that disclosed in U.S. Pat. No. 5,805,748 into a beam of 600 μm square.

The first laser crystal 5 consists of a Nd:YVO₄ crystal having a Nd³⁺ concentration of 0.25 atomic % and 0.9 mm long in the axial direction. The end surface of the first laser crystal 5 adjacent to the optical assembly 2 is provided with a dielectric multi-layer film mirror 3 which has a reflectivity of no less than 99% with respect to the 1,064 nm laser output and no more than 3% with respect to the 809 nm incident pump radiation. The second laser crystal 6 consists of a Nd:YVPO₄ crystal having a Nd³⁺ concentration of 0.5 atomic % and 0.5 mm long in the axial direction. The third laser crystal 7 consists of a Nd:YVO₄ crystal having a Nd³⁺ concentration of 1.0 atomic % and 3 mm long in the axial direction.

The end surface of the third laser crystal 7 adjacent to an output mirror 4 is provided with a coating which has a reflectivity of no more than 0.25% with respect to the 1,064 nm laser output. The third laser crystal 7 can absorb 90% of the incident pump radiation if the axial length of the third laser crystal is at least 0.3 mm. If the laser crystal is somewhat longer than this minimum length, the manufacturing and handling of the composite laser crystal can be facilitated, and the composite laser crystal can better accommodate for variations in the wavelength of the incident pump radiation due to changes in temperature and variations in the laser diode.

The opposing surfaces of the first laser crystal 5 and second laser crystal 6 are made to make an optical contact, and joined to each other by thermal bonding. The opposing surfaces of the second laser crystal 6 and third laser crystal 7 are likewise joined to each other. Thereby, the three Nd:YVO₄ crystals having different Nd³⁺ concentrations are integrally joined to one another into a simple composite crystal 4.4 mm long.

The faces of this composite crystal other than those through which the pump radiation and laser output pass or side faces thereof are retained by a heat sink 10 made of a copper base alloy via a 0.1 mm thick indium plate which is interposed between them to improve mutual contact and enhance thermal conduction. The heat sink 10 removes heat from the composite crystal or laser crystal including the three individual laser crystals having different Nd³⁺ concentrations by thermal conduction. The distribution of end pumped absorption may be made uniform owing to the variation of the rare earth ion concentration in the direction of pumping, and this distribution is well suited for the heat sink to remove the heat.

The output mirror 4 has a dielectric multi-layer film coated on a concave surface of a glass substrate so that a reflectivity of 90% may be achieved for Nd:YVO₄ laser at 1,064 nm. A laser resonator is formed between the output mirror 4 and the dielectric multi-layer film mirror (reflecting mirror) 3 so that a laser output of 18 W at 1,064 nm may be achieved without damaging the laser crystal when the output of the laser diode is 40 W.

The individual laser crystals may be bonded to each other by thermal bonding (for high power applications), optical contact (for medium power applications) and using a optical bonding agent (for low power applications), and the bonding method may be selected according to each particular need. It is also possible to place the individual crystals simply one next to the other in close contact with one another.

### Second Embodiment

Referring to FIG. 2 showing the second embodiment of the present invention, the laser diode 1 serving as a pumping light source, pumping optical system 2 and output mirror 4 are similar to those of the first embodiment. The dimensions of the first laser crystal 5 are similar to those of the counterpart in the first embodiment. The dielectric multi-layer film 3 on the side of the pumping optical system 2 is similar to that of the first embodiment, but the opposite face of the first laser crystal 5 is coated with a dielectric layer having a low reflectivity for the Nd:YVO₄ laser at 1,064 nm.

The second laser crystal 6 is similar to that of the first embodiment in terms of dimensions and Nd³⁺ concentration. However, the two ends surfaces through which the pumping light passes are each coated with a dielectric layer having a low reflectivity for both the Nd:YVO₄ output laser at 1,064 nm and the pumping laser at 809 nm. The second laser crystal 6 is spaced from the first laser crystal 5 by approximately 200 μm as denoted with numeral 13 in FIG. 2.

The third laser crystal 7 is not different from that of the first embodiment in terms of dimensions and Nd³⁺ concentration, but a dielectric layer coated on each end face thereof. The dielectric layers has a low reflectivity for both the Nd:YVO₄ output laser at 1,064 nm and the pumping laser at 809 nm. The second laser crystal 6 is spaced from the second laser crystal 6 by approximately 200 μm as denoted with numeral 13 in FIG. 2.

These three individual laser crystals are retained by a heat sink 10 made of a copper based alloy at the side faces or the faces other than those through which laser light or pumping light passes to cool them from the side faces. A 0.1 mm thick indium plate is interposed between the individual laser crystals and heat sink 10 for improved heat conduction.

The three laser crystals of the solid state laser of the second embodiment are not placed in close contact with one another or bonded to one another as opposed to those of the first embodiment. Owing to the fact that a gap 13 smaller than the length of each laser crystal is provided between the adjacent laser crystals, a laser output of 18 W at 1,064 nm was obtained similarly as the first embodiment without damaging the laser crystal when the output of the laser diode was 40 W.

### Third Embodiment

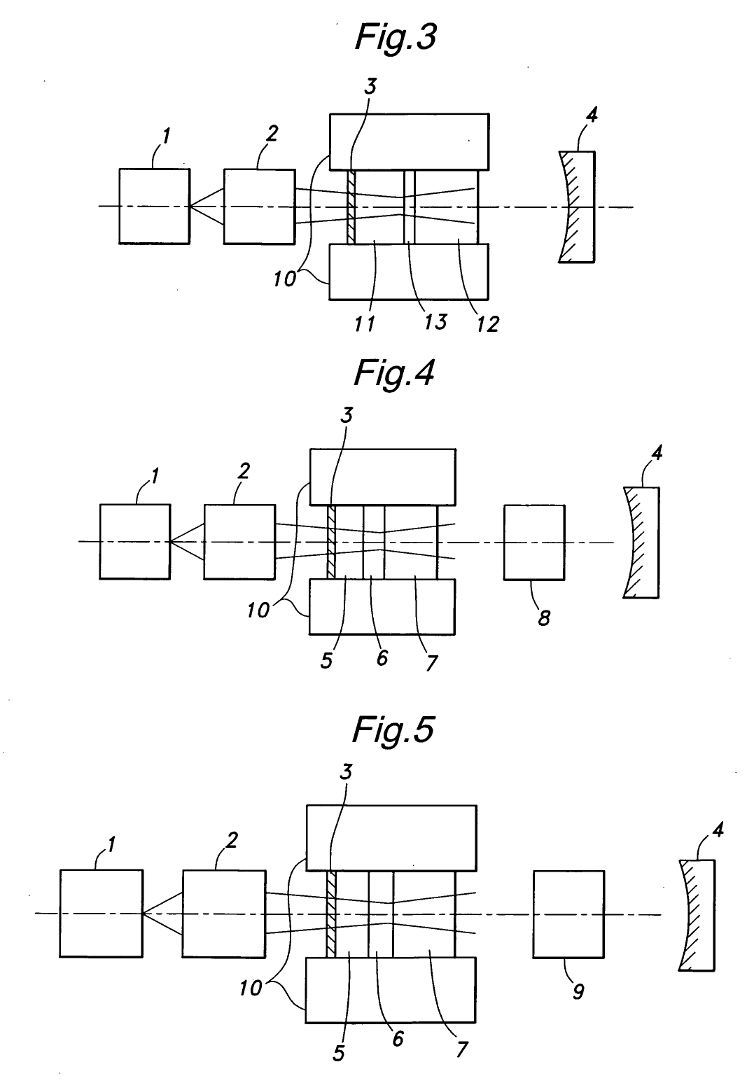

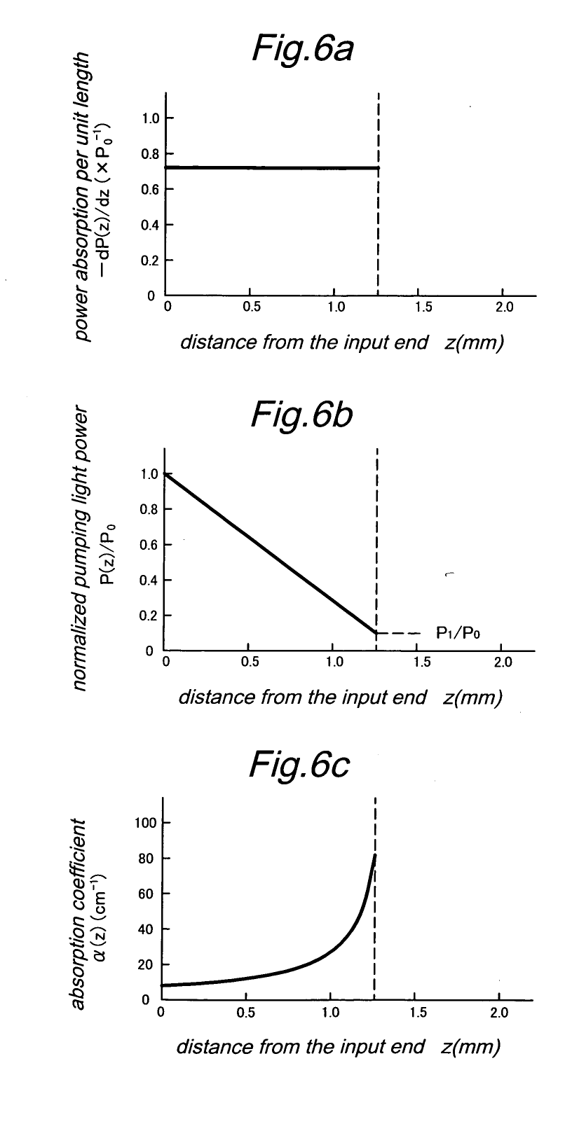

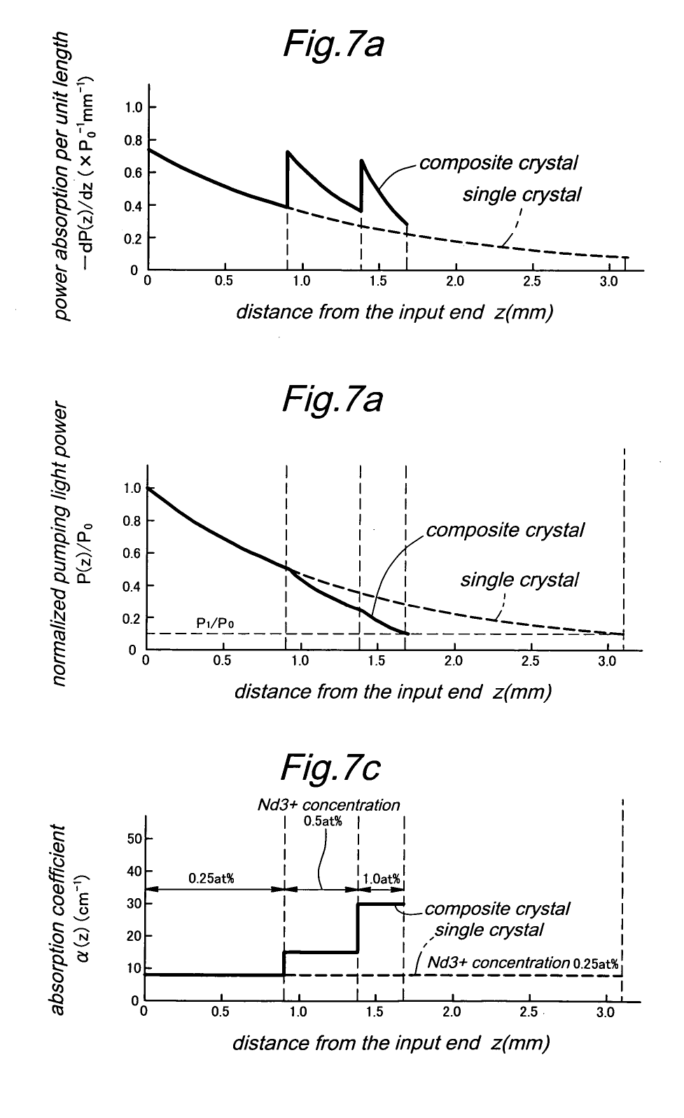

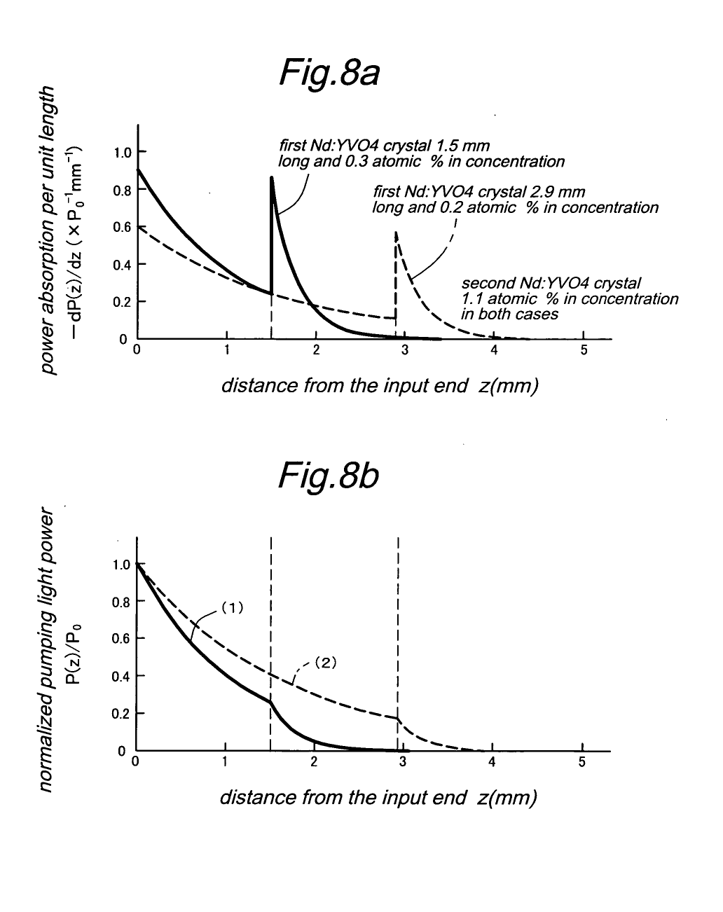

Referring to FIG. 3 showing the third embodiment of the present invention, the laser crystal in this case consisted of two individual laser crystals 11 and 12 made of Nd:YVO₄ crystals. The face of the first laser crystal 11 closer to the pumping optical system 2 was provided with a dielectric multi-layer film mirror 3, and the second laser crystal 12 was spaced from the first laser crystal 11 by a gap 13.

The first laser crystal 11 had a Nd³⁺ concentration of 0.2 atomic %, and was 1.5 mm long. The face of the first laser crystal closer to the pumping optical system was provided with a dielectric multi-layer film mirror 3, and the opposite face was coated with a dielectric layer having a low reflectivity for both the Nd:YVO₄ laser at 1,064 nm and pumping laser at 808 nm.

The second laser crystal 12 had a Nd³⁺ concentration of 1.1 atomic %, and was 3.5 mm long. The two opposite faces through which the pumping laser and output laser respectively pass through were each coated with a dielectric layer having a low reflectivity for both the Nd:YVO₄ laser at 1,064 nm and pumping laser at 808 nm.

The first and second laser crystals 11 and 12 were spaced from each other by a gap 13 of approximately 200 μm. These two individual laser crystals were retained by a heat sink 10 made of a copper based alloy at the side faces or the faces other than those through which laser light or pumping light passes to cool them from the side faces. A 0.1 mm thick indium plate was interposed between the individual laser crystals and heat sink 10 for improved heat conduction.

Similarly as the first and second embodiments, a laser output of 17 W at 1,064 nm was obtained without damaging the laser crystal when the output of the laser diode was 40 W. The output was slightly smaller than those of the previous embodiments, but this embodiment is superior to the previous embodiments in terms of cost and suitability for mass production.

### Fourth Embodiment

Referring to FIG. 4 showing a fourth embodiment of the present invention, this solid state laser is similar to that of the first embodiment except for the use of an output mirror 4 and nonlinear laser crystal 8. The nonlinear laser crystal 8 was made of potassium titanyl phosphate KTiOPO₄ (KTP), and was cut at the angles θ=90° and φ=24° to produce a second harmonic of the oscillating laser at 1,064 nm.

The output mirror 4 is formed by applying a dielectric multi-layer film on a concave surface of a glass substrate so that a reflectivity of 99% or higher may be achieved for the Nd:YVO₄ laser at 1,064 nm and a reflectivity of 3% or lower for the second harmonic at 532 nm. This solid state laser produced a laser output of up to 11 W at 532 nm when the output of the pumping laser diode was 40 W.

KTP was used in this embodiment as the nonlinear laser crystal 8, but other nonlinear optical crystals such as potassium niobate KNbO₃, β-potassium borate BaB₂O₄ (β-BBO) and lithium triborate LiB₃O₃ or periodically poled devices made of crystals such as KTP, lithium niobate LiNbO₃ and lithium tantalate LiTaO₃ can also be used.

### Fifth Embodiment

Referring to FIG. 5 showing a fifth embodiment of the present invention, a Q-switch using an acousto-optical effect was placed in a laser resonator 9 between the laser crystal and output mirror 4, but this embodiment is otherwise similar to the first embodiment. High frequency power was externally supplied to the Q-switch 9 to on-off modulate the switch.

In this case, the laser pulses were produced when the high frequency power was turned off. The high frequency power was turned on and off at the frequency of 20 kHz, and the repetitive pulses were generated synchronously. When the pumping laser output was 40 W, a time-averaged laser output of 16 W was obtained.

In this case, the Q-switch relied on an acousto-optical effect, but other active devices using electro-optical or other effects may also be used for the Q-switch. It is also possible to use passive Q-switches such as semiconductor saturable absorption mirror made of semiconductor material and saturable absorbers made of Cr⁴⁺:YAG.

The distribution of pumping light absorption along the length of the laser crystal was made uniform by using a composite laser crystal consisting of three individual laser crystals in the cases of the first, second, fourth and fifth embodiments consisting of two individual laser crystals in the case of the second embodiment. It is also possible to use four or more individual laser crystals to more evenly distribute the absorption of the pumping light and increase the permissible input of the pumping light and/or to more narrowly focus the pumping light so that the maximum output of the laser diode pumped solid state laser may be increased even further.

The wavelength which is preferentially reflected by the dielectric multi-layer film mirror 3 and output mirror 5 or which is minimally reflected by the low-reflectivity coating applied to the laser crystals was 1,064 nm to obtain an output laser of this wavelength in the foregoing embodiments. However, it is also possible to produce laser output of different wavelengths such as 1,340 nm by appropriately selecting the wavelength properties of such reflecting mirrors and low-reflective coatings.

YVO₄ was used in the laser crystal as the material into which rare earth ions were added in the foregoing embodiments, but other materials such as Y₃Al₅O₁₂ (YAG), LiYF₄ (YLF) and GdVO₄ may also be used as long as the selected material can be pumped by a laser diode. Also various rare earth ions may be added thereto at various concentrations. Such materials may not be limited to crystals but may also consist of glass or other amorphous materials or polycrystalline materials, and various rare earth ions may be added thereto at various concentrations.

The reflecting mirror that forms the laser resonator consisted of the dielectric multi-layer film mirror 3 provided on the first laser crystal in the foregoing embodiments, but similar results can be obtained even when a similar reflecting mirror is placed between the first later medium 5 and pumping optical system 2 instead of such a reflecting mirror.

Although the present invention has been described in terms of preferred embodiments thereof, it is obvious to a person skilled in the art that various alterations and modifications are possible without departing from the scope of the present invention which is set forth in the appended claims.

1. A solid state laser, comprising:
a laser resonator including an output mirror, a laser crystal containing rare earth ions and at least one reflecting mirror, said output mirror, laser crystal and reflecting mirror being arranged along an optical axis,
a laser diode for emitting pumping light;
a pumping optical system for focusing pumping light emitted from said laser diode onto said laser resonator coaxially with said optical axis;
wherein said laser crystal comprises a plurality of individual laser crystals arranged along said optical axis, said individual laser crystals being each made of a material having a composition expressed by a same chemical formula and having progressive higher concentrations of said rare earth ions toward said output mirror.

2. A solid state laser according to claim 1, wherein said individual laser crystals are disposed in close mutual contact.

3. A solid state laser according to claim 1, wherein said individual laser crystals are integrally bonded to each other.

4. A solid state laser according to claim 1, wherein said individual laser crystals are spaced from each other by a gap substantially smaller than a length of a shortest one of said individual laser crystals.

5. A solid state laser according to claim 1, wherein said laser crystal is provided with a heat sink on side faces thereof for removal of heat.

6. A solid state laser according to claim 1, wherein said individual laser crystals are made of a material selected from a group consisting of YVO₄, Y₃Al₅O₁₂ (YAG), LiYF₄ (YLF) and GdVO₄.

7. A solid state laser according to claim 1, wherein said rare earth ions consist of neodymium ions.
